(19) United States
(12) Patent Application Publication
(10) Pub. No.: US 2011/0186527 A1
(43) Pub. Date: Aug. 4, 2011

(54) Method And A Means For The Separation Of Oil From A Coolant/Lubricant

(75) Inventor: Michael NIELSEN, Svendborg (DK)

(73) Assignee: Steffen NIELSEN, Svendborg (DK)

(21) Appl. No.: 12/696,732

(22) Filed: Jan. 29, 2010

(51) Int. Cl. F01M 11/03; B01D 21/00

(52) U.S. Cl. 210/791; 210/800; 210/167.02

(57) ABSTRACT

When, according to the invention, an oil separator (1) is configured with a core of lengths of pipe (4) extending in parallel, and an oil-containing agent (5) is conveyed through these channels (3) in the pipes (4), the oil molecules will settle as an oil coating (6) on the channel walls. At some point, the pressure of the medium will increase, when the flow is reduced, whereby the oil will be pressed out of the pipes (4). Then, upon settling, the oil separation will be resumed, and the separated oil (6) may be collected, while the agent (12) cleaned of oil may be reused and, following reuse, be fed to the cleaning system and its oil separator.

### THE PRIOR ART

The invention relates to a method of separating oil from a coolant/lubricant which is fed to a cleaning system, e.g. from a CNC machine or the like, said cleaning system comprising filters for removing impurities, metals, as well as an oil separator for removing oil, so that the oil-free and cleaned agent may be recirculated for re-use as a coolant/lubricant, as well as a means for performing the method.

Cleaning of coolants/lubricants is a prerequisite for the re-use of the agent, it being ensured thereby that oil, such as drain oil, oxides, metals and other impurities are removed by the passage through a cleaning system, which includes an oil separator.

Previously known methods and systems are very extensive, since they must contain a plurality of buffer chambers because of a different capacity in the individual elements. This is a drawback, as this makes it impossible to achieve a continuous cleaning and filtration and thereby regeneration of the emulsion amount, which constitutes the coolant/lubricant.

### THE OBJECT OF THE INVENTION

It is the object of the invention to remedy these defects and drawbacks by optimizing the oil separation in order to thereby make it possible to reduce the volume of the cleaning system, so that this is as compact as possible, just as particularly the oil separation is as effective as possible.

This makes it possible to achieve a compact cleaning system having a great oil separating capacity, as the oil molecules precipitate more easily by the passage through relatively small and short channels. With a suitably large number of channels, the emulsion will precipitate without accumulations, as the liquid is conveyed continuously through the channels in the separator.

This is achieved according to the invention by a method, wherein the oil-containing agent is fed to channels and is then conveyed through these channels, which are formed in lengths of pipe, said lengths of pipe being disposed in the oil separator, whereby the oil settles, precipitates on the pipe walls, while the agent cleaned of oil is discharged from the other end of the lengths of pipe.

In this surprisingly simple manner, the separator constitutes a system of channels having such a great overall surface that the necessary flow of the oil-containing agent may take place continuously, and, at the same time, the channels will slow down or reduce the flow rate and ensure the effective oil separation in that the oil adheres to the channel wall

When the oil is allowed to reduce the bore of the channels and thereby increase the pressure of the medium, the oil will be expelled readily when a suitable pressure of the medium has been reached,

When the lengths of pipe provided with channels are made of plastics, and the bore of the channels is designed to be between 3 and 6 mm, a very effective separation will be achieved, whereby the oil will adhere as a layer of oil along the channel walls.

When the lengths of pipe are configured as a nest of pipes having a preferably rectangular cross-sectional shape, these nests of pipes may be stacked easily and readily to form the separating part of the separator.

Finally, it is expedient to allow the feed to the lengths of pipe to take place at the bottom and the discharge at the top, as an automatic separation will take place hereby, where the oil will float up onto the surface.

### THE DRAWING

The invention will be described more fully below with reference to the drawing, in which

FIG. 1 shows an example of a cleaning system having an oil separator, seen in a partial section,

FIG. 2 shows a section of the lengths of pipe in the separator, seen in the direction II-II in FIG. 1,

FIG. 3 shows a sectional view of a pipe with a little oil along the wall,

FIG. 4 shows the same pipe with a little more oil,

FIG. 5 shows the same pipe with much oil,

FIG. 6 shows a longitudinal section of the pipe, seen in the direction VI-VI in FIG. 5, and

FIG. 7 shows oil being pressed out of a pipe.

### DESCRIPTION OF AN EXEMPLARY EMBODIMENT

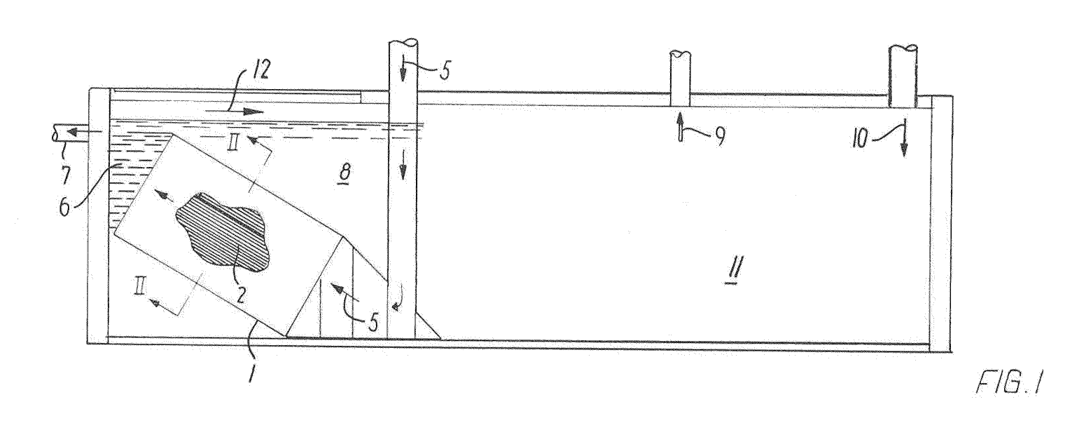

The invention will be described below on the basis of an example of a cleaning system having an incorporated oil separator, as is shown in FIG. 1.

The system comprises a vessel 11, to which coolant/lubricant 10 is conveyed, and from which cleaned liquid is sucked via a discharge pipe, as indicated by an arrow 9.

Also shown is a further sub-chamber 8, which serves as a collection vessel for the oil-separated medium, which is fed to the oil separator via a channel, as indicated by an arrow 5.

The oil-containing agent 5 is fed at the bottom to the oil separator 1, which is inclined in the shown example, said oil separator being configured with a core of combined nests of channels or rods 2, as will be explained later.

When the medium 5 is fed through a large number of channels, the flow rate will be so suitable that the oil in the agent will adhere, that is precipitate, along the channel wall.

At some point, the pressure will become so great that the oil deposit is expelled, removed and may be collected, as it precipitates as oil 6 at the surface, where it may be sucked out e.g. via a pipe, as indicated by an arrow 7.

As indicated by an arrow 12, the agent freed of oil is conveyed out into the chamber 8 and 11, from which the cleaned agent may be sucked out as a cleaned agent 9 in order to be re-used as a coolant/lubricant for CNC machines or the like.

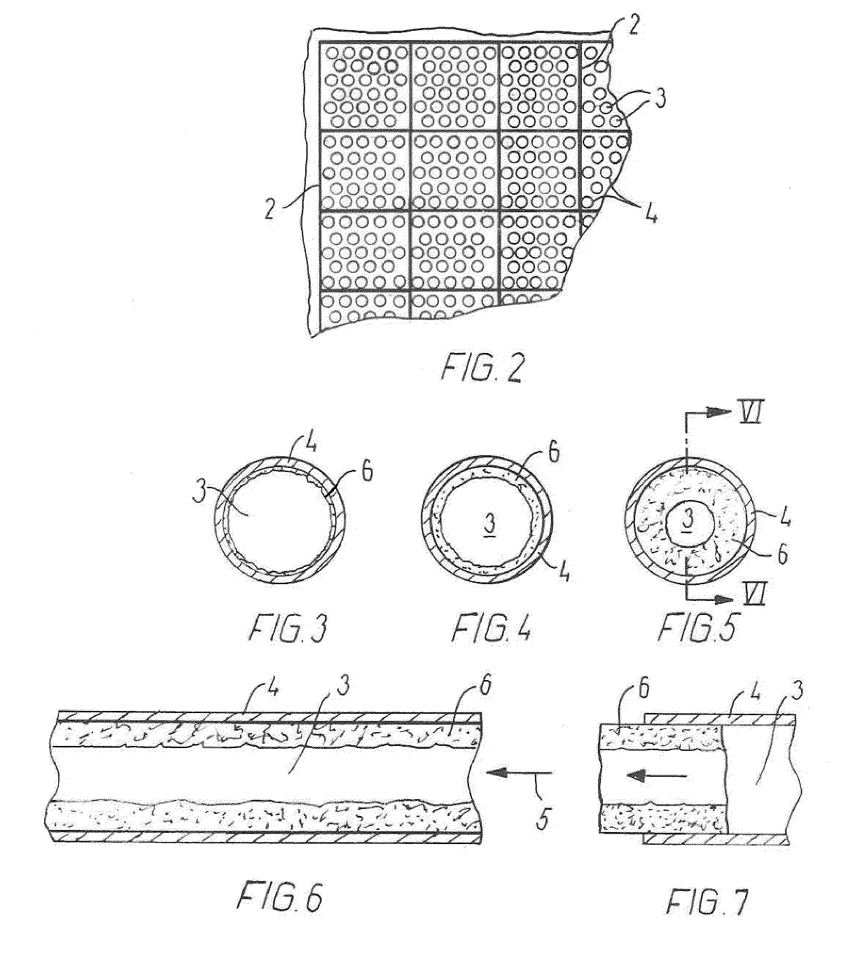

The oil separator will be described now with reference to FIGS. 2-7.

The interior of the separator 1, through which the oil-containing agent passes, comprises a plurality of nests of channels 2, as shown seen from the end in FIG. 2.

In the example shown, each nest is configured as cross-sectionally rectangular rod having up to 100 channels 3, which constitute the overall bore in the lengths of pipe 4.

These pipes are preferably made of polypropylene, as the oil molecules tend to adhere to this material and thereby to the individual pipe walls, as indicated in FIG. 3.

These oil molecules form a floating oil layer 6, and as this layer increases, as indicated in FIG. 4, in the bore, the flow finally becomes so small, as indicated in FIG. 5, that the oil layer 6 will be pressed out of the pipe 4, as indicated in FIG. 7.

This simple principle ensures an oil separation which is so effective that a continuous cleaning of the agent may take place in a closed circuit.

In addition to the oil separation itself, also a conditioning of the agent is achieved, as a reduction of the content of graphite and aluminium oxide takes place at the same time, Hereby, the agent will be clean without any obnoxious smells and with a minimal risk of bacterial growth.

The dimensions of the individual pipes are preferred to have a bore 3 of between 3 and 6 mm² and a length of between 50 and 100 cm.

This ensures an effective and harmonious adaptation of the flowing amount relative to its pressure.

The oil molecules will be deposited effectively along the channel wall because of the relatively low flow rate and large internal wall face, and expulsion of the oil will take place automatically, when the pressure, which depends on the bore, is suitably high, as is indicated in FIGS. 5 and 7.

Since no moving parts are incorporated in the separator, this will work with-out any risk of operational stoppages. To this should be added that the channels in the individual nests of pipes may be manufactured by extrusion, whereby their manufacture and in particular mounting in the oil separator are facilitated to a considerable degree.

1. A method of separating oil from an oil-containing coolant/lubricating agent, which is fed to a cleaning system, e.g. from a CNC machine or the like, said cleaning system having filters for removing impurities and metals, and having an oil separator for removing oil, for providing an oil-free and cleaned coolant/lubricating agent for recirculation and re-use as a coolant/lubricating agent, the method comprising feeding the oil-containing agent to channels (13) and conveying the oil-containing agent through these channels (3), the channels formed by lengths of pipe (4), said lengths of pipe being disposed in the oil separator (1), as the oil containing agent passes therethrough, settling and precipitating oil (6) on walls of the pipes (4), cleaning the agent of oil, and discharging the cleaned agent (8) from ends of the lengths of pipe (4).

2. A method according to claim 1 further comprising pressing the precipitated oil (6) out of the lengths of pipe (4), when a bore of the channel (3) is reduced to an extent that a pressure of the agent increases sufficiently for pressing-out the oil (6).

3. A method according to claim 1 wherein the lengths of pipe (4) are made of plastic with a bore of between 3 and 6 mm².

4. A method according to claim 3 wherein the plastic is polypropylene.

5. A method according to claim 3 further comprising assembling adjacent lengths of pipe (4) to form a joined nest of pipes (2) having a preferably rectangular cross-sectional shape.

6. A method according to claim 4 further comprising providing a plurality of combined nests of pipes (2) for use as the lengths of pipe (4) located in the oil separator (1).

6. A method according to claim 1 further comprising disposing the lengths of pipe (4) such that an inlet feed (5) to the channels (3) is disposed lower than a discharge end of the channels (3),

7. An oil separator for use in a cleaning system for cleaning an oil-containing coolant/lubricating agent, received from a CNC machine or the like, said cleaning system having filters for removing impurities and metals, and using the oil separator for removing oil, for providing an oil-free and cleaned coolant/lubricating agent for recirculation and re-use as a coolant/lubricating agent, the oil separator comprising a plurality of channels (13) formed by a plurality of lengths of pipe (4), said lengths of pipe being disposed in a vessel (11) within a sub-chamber (8), oil containing agent being fed to the sub-chamber and passed through the channels such that oil (6) settles and precipitates on walls of the pipes (4), cleaning the agent of oil, the cleaned agent (8) discharged from ends of the lengths of pipe (4).

8. The oil separator according to claim 7 wherein the lengths of pipe (4) are made of plastic with a bore of between 3 and 6 mm².

9. The oil separator according to claim 8 wherein the plastic is polypropylene.

10. The oil separator according to claim 7 wherein the lengths of pipe (4) are assembled to form a joined nest of pipes (2) having a preferably rectangular cross-sectional shape.

11. The oil separator according to claim 10 wherein the oils separator includes a plurality of joined nests of pipes (2).

12. The oil separator according to claim 7 wherein the lengths of pipe are disposed such that an inlet end of the channels is lower than a discharge end of the channels.
